(19) United States
(12) Patent Application Publication
(10) Pub. No.: US 2021/0165501 A1
(43) Pub. Date: Jun. 3, 2021

(54) CUSTOMIZED RADIO FREQUENCY IDENTIFICATION

(71) Applicant: Hewlett-Packard Development Company, L.P., Spring, TX (US)

(72) Inventors: Fangyong Dai, Spring, TX (US); Richard S. Lin, Spring, TX (US); Xiang Ma, Spring, TX (US); Baosheng Zhang, Spring, TX (US)

(73) Assignee: Hewlett-Packard Development Company, L.P., Spring, TX (US)

(21) Appl. No.: 17/043,814

(22) PCT Filed: Aug. 24, 2018
(86) PCT No.: PCT/US2018/047935

§ 371 Date: Sep. 30, 2020

(51) Int. Cl. G06F 3/023; H04W 12/033; H04W 4/80; G06K 19/07; H04L 9/32

(52) U.S. Cl. CPC G06F 3/0238; H04W 12/033; H04L 2209/805; G06K 19/0723; H04L 9/3226; H04W 4/80

(57) ABSTRACT

In some examples, a non-transitory machine readable medium can include instructions executable to a processing resource to generate a radio frequency identification (RFID) identifier formed of a plurality of characters, transmit the RFID identifier to a host, responsive to an input to an input mechanism, identify a predetermined character that corresponds to the input, change a character of the plurality of characters to the predetermined character to form a customized RFID identifier, and transmit the customized RFID identifier to the host.

### BACKGROUND

Input devices such as keyboards are utilized in a variety of applications. For example, keyboards may be utilized to provide letters, numbers and/or characters, among other possible information, to a host such as a computer, among other possibilities.

### BRIEF DESCRIPTION OF THE DRAWINGS

FIG. 1 is a block diagram of an example of a wireless input device for customized radio frequency identification according to the disclosure.

FIG. 2 is an example of a controller consistent with the disclosure.

FIG. 3 is an example of a non-transitory machine readable medium consistent with the disclosure.

FIG. 4 is a block diagram of an example of a system including a wireless input device for customized radio frequency identification according to the disclosure.

FIG. 5 is a block diagram of another example of a system including a wireless input device for customized radio frequency identification according to the disclosure.

FIG. 6 is a block diagram of yet another example of a system including a wireless input device for customized radio frequency identification according to the disclosure.

FIG. 7 is a block diagram of still another example of a system including a wireless input device for customized radio frequency identification according to the disclosure.

### DETAILED DESCRIPTION

Radio frequency identification (RFID) components such as tags and/or chips can be used to identify and/or track objects. For instance, an RFID component can wirelessly transmit a RFID identifier specific to the RFID component to permit identification and/or tracking of an object. Some approaches can employ a fixed RFID identifier to permit identification and/or tracking of an object. However, such approaches do not contemplate varying a RFID identifier associated with the RFID component. For instance, once a RFID identifier is programmed or otherwise associated with a RFID component the RFID identifier remains fixed and does not change.

Other wireless communication methods can vary information transmitted wirelessly. For instance, a keyboard or other device equipped with a BLUETOOTH® based wireless hardware can vary information transmitted wirelessly, for instance, to convey to a host a key on the keyboard selected by a user, among other possibilities. However, such approaches can employ costly hardware (e.g., BLUETOOTH® based wireless hardware). Additionally, such approaches may not provide identification information once paired following a handshaking protocol. As such, the approaches may be less secure (than approaches detailed herein). As used herein, a “handshaking protocol” refers to a negotiation process that dynamically sets parameters of a communication channel between two entities before communication over the communication channel begins.

As such, the disclosure is directed to customized radio frequency identification. For instance, customized radio frequency identification can include generation of a RFID identifier, identification of a predetermined character that corresponds to an input to a wireless input device, changing a character of the RFID identifier to the predetermined character to form a customized RFID identifier and transmission of the customized RFID identifier to a host, as detailed herein. Such customized radio frequency identification can provide a secure wireless transmission mechanism due to changing of the character responsive to an input (e.g., a keystroke), be cost effective (e.g., due to an absence of BLUETOOTH® based wireless hardware/antennae), and/or permit the wireless input device to provide information (e.g., information representative of an input to the wireless input device) to a host.

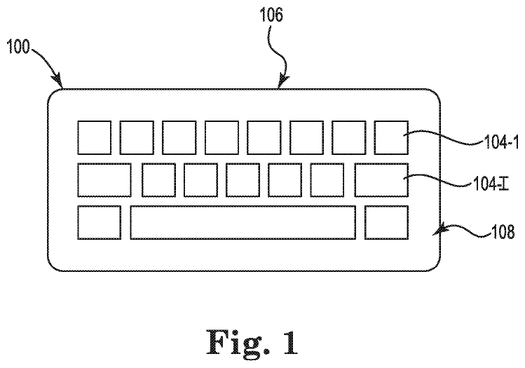

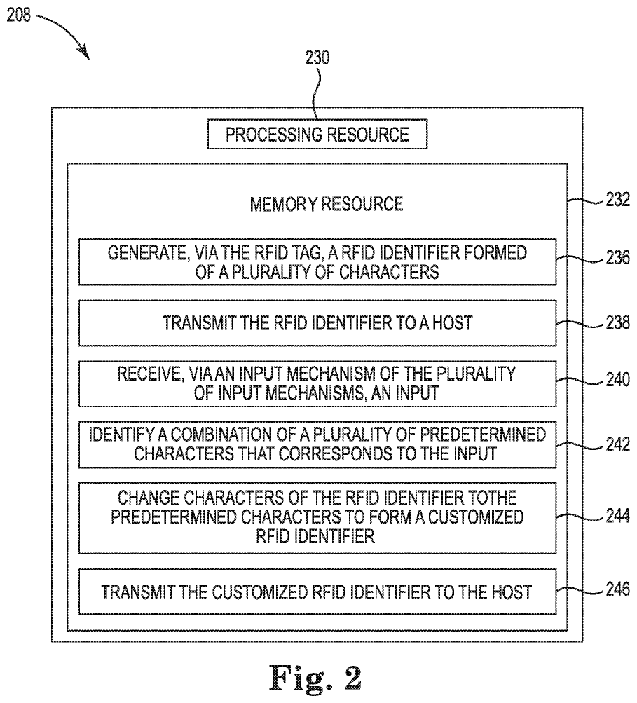

FIG. 1 is a block diagram of an example of a wireless input device 100 for customized radio frequency identification according to the disclosure. As illustrated in FIG. 1, the wireless input device 100 can include a plurality of input mechanisms 104-1, . . . , 104-I (herein collectively referred to as input mechanisms 104), a RFID component 106, and a controller 108 (as detailed with respect to FIG. 2), among other possibilities.

The wireless input device 100 refers to a device including hardware that can wirelessly communicate (send and/or receive) wireless information with another device. For instance, the wireless input device can communicate wireless information in accordance with an RFID standard, a Wireless Gigabit Alliance (WGig) standard, ZigBee, and/or an electrical and electronics engineers (IEEE) 802 based standard (e.g. IEEE 802.11 Wi-Fi standard), among other possible wireless standards. In some examples, the wireless input device 100 can wirelessly communicate in accordance a RFID standard.

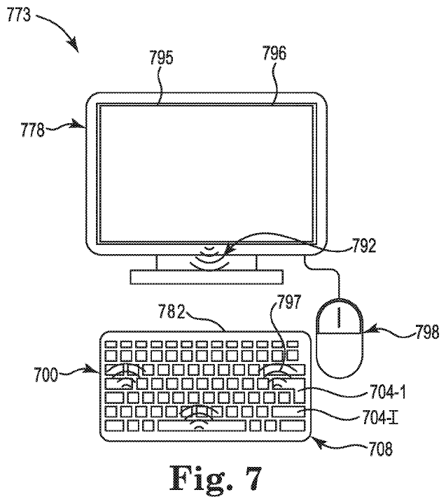

Examples of wireless input device include keyboards, mice, among other types of wireless input devices. For instance, in some examples the wireless input device can be keyboard, as illustrated in FIG. 1. However, the wireless input device is not so limited. For instance, in some examples the wireless input device can be a wireless mouse. In some examples, the wireless input device can include a keyboard and a wireless mouse (e.g., as illustrated in FIG. 7), among other possibilities.

In any case, the wireless input device includes a plurality of input mechanism such as the input mechanisms 104. As used herein, input mechanisms refer to hardware having a corresponding output. Examples of input mechanisms include a key, a switch, a button, and/or a touch screen such as a capacitive touch screen. For instance, a space bar on a keyboard has a corresponding output (a signal recognizable by a host) to produce a space when an input is provided to the space bar (e.g., by an end user of the keyboard). Similarly, numeric, alphabetic, and/or alpha-numeric keys have respective corresponding outputs responsive to an input. An input can be provided by actuation and/or contact of an input mechanism 104, among other possibilities.

As used herein, being “actuated” or “actuation” refers to a key, button, or other input mechanism moving along a path of travel to contact a circuit or otherwise generate a signal responsive to the input mechanism moving along the path of travel. For example, a key such as spacebar can be actuated from a default position (e.g., where no signal is generated) to another position (e.g., where a signal is generated to provide the corresponding output of a space). In some examples, an input can include depression of an individual key of a plurality of keys of the wireless input device and/or release of an individual key of the plurality of keys of the wireless input device. In such examples, the depression of the individual key can provide a same or different predetermined character than the release of the individual key cap.

Similarly, a switch of a wireless input device can be actuated from a first position (e.g., an off position) to a second position (e.g., an on position) to provide a change in signal or generate a signal. That is, a switch can be activated from an on position to an off position or from an off position to an on position. In some examples, a position of a switch can be altered to change a voltage, current, and/or other signal provided by the switch. For instance, a switch can be rotated or otherwise manipulated to a change a voltage, current, and/or other signal provided by the switch.

In some examples an input can include a contact or an absence of contact with a touch screen. As used herein, “contact” refers to a physical impact of a component that causes a change in a signal and/or generation or a signal. For example, a touch screen such as a capacitive touch screen can be contacted (e.g., at a portion of the touch screen having a graphical representation of a spacebar) to generate or change a signal (e.g., to provide the corresponding output of a space). Similarly, as used herein “an absence of contact” refers to a lack of physical impact of a component.

The RFID component 106 refers to device having a circuit such as an integrated circuit for storing and processing information, modulating and demodulating a radio-frequency (RF) signal, and/or collecting power from a RFID reader signal, as well as an antenna for receiving and transmitting a signal. That is, the RFID component 106 refers to a RFID tag and/or a RFID chip that can communicate in a passive and/or active manner accordance with an applicable RFID standard such as an ISO/IEC 18000 standard. The RFID component 106 can be a passive RFID component or an active RFID component.

For instance, in some examples, the RFID component can be a passive RFID component. As used herein, a passive RFID component refers to an RFID component that converts radio-waves from RFID reader into its power source via inductive coupling and can transmit of a response signal back to RFID reader in form of load modulation or otherwise. That is, a passive RFID component does not have its own power source, such as a dedicated battery and/or capacitor.

In some examples, the RFID component 106 can be an active RFID component. As used herein, an active RFID component refers to an RFID component that responds an RFID reader polling frequency and can send a response signal generated from a dedicated power source such as a “data scattered” signal that can be transmitted to an RFID reader. That is, an active RFID component does have its own power source, such as a dedicated battery and/or capacitor.

While described in various examples as being a passive RFID component or an active RFID component the disclosure is not so limited. For instance, in some examples the RFID component can be a power assisted active RFID component that can unitize power from an RFID reader and can utilize power from a dedicated power source such as a battery or capacitor.

The RFID component 106 can be ultra-high frequency (UHF). For example, RFID component 106 can be a UHF RFID component that communicates with an RFID reader in a frequency band range of 300 Megahertz (MHz) to 3 Gigahertz (GHz). In some examples, the RFID component can be a low frequency (LF) RFID component that communicates with an RFID reader in a frequency band range of 3 kilohertz (KHz) to 300 KHz. In some examples, the RFID component can be a high frequency (HF) RFID component that communicates with an RFID reader in a frequency band range of 3 MHz to 30 MHz. In some examples, the RFID component can be an ultra-wideband (UWB) RFID component that communicates with an RFID reader in a frequency band range of 3 GHz to 11 GHz.

A transmission range between RFID component and RFID reader included in a host can be approximately one meter, although examples of the disclosure are not limited to one meter. For instance, the transmission range can be greater than one meter or less than one meter. The transmission range between component and a RFID reader can be configurable. For example, a transmission power of RFID component and/or RFID reader can be increased or decreased to increase or decrease a resultant transmission range.

The RFID component 106 can be coupled to a processor (not illustrated in FIG. 1 for ease of illustration) such as a processor included in the controller 108. For instance, RFID component can be coupled to processor via a serial bus. As used herein, a serial bus can refer to a communication system that transfers data between components of a computing device. In some examples, RFID component can be coupled to a processor via an Inter-Integrated Circuit (I2C) bus such that data can be transmitted between RFID component 106 and the processor. In some examples, the RFID component 106 can be coupled to a processor via a serial peripheral interface (SPI) bus such that data can be transmitted between RFID component and a processor.

FIG. 2 is an example of a controller 208 consistent with the disclosure. The controller 208 can be analogous to or similar to controller 108, 408, 508, 608, 708 as described with respect to FIGS. 1, 4, 5, 6, and 7, respectively. As described herein, the controller 208 can perform a function related to customized radio frequency identification. Although the following descriptions refer to an individual processing resource and an individual machine-readable storage medium, the descriptions can also apply to a system with multiple processing resources and multiple machine-readable storage mediums. In such examples, the controller 208 can be distributed across multiple machine-readable storage mediums and the controller 208 can be distributed across multiple processing resources. Put another way, the instructions executed by the controller 208 can be stored across multiple machine-readable storage mediums and executed across multiple processing resources, such as in a distributed or virtual computing environment.

As illustrated in FIG. 2, the controller 208 can comprise a processing resource 230 and a memory resource 232. The memory resource 232 stores machine-readable instructions 236, 238, 240, 242, 246, 248 to cause the processing resource 230 to perform an operation relating to customized radio frequency identification.

Processing resource 230 can be a central processing unit (CPU), microprocessor, and/or other hardware device suitable for retrieval and execution of instructions stored in memory resource 232. Memory resource 232 can be a machine-readable storage medium can be any electronic, magnetic, optical, or other physical storage device that stores executable instructions. Thus, machine-readable storage medium can be, for example, Random Access Memory (RAM), an Electrically-Erasable Programmable Read-Only Memory (EEPROM), a storage drive, an optical disc, and the like. The executable instructions can be “installed” on a wireless input device and/or a host. Machine-readable storage medium can be a portable, external or remote storage medium, for example, that allows the wireless input device and/or a host (or a different device) to download the instructions from the portable/external/remote storage medium. In this situation, the executable instructions can be part of an “installation package”. As described herein, machine-readable storage medium can be encoded with executable instructions related to customized radio frequency identification. While FIG. 2 describes instructions 236, 238, 240, 242, 246, 248 with respect to the controller 208, some or all of the instructions 236, 238, 240, 242, 246, 248 can be stored and/or executed in a distributed computing environment such as in a cloud infrastructure that can manage or otherwise interact with a wireless input device and/or a host.

The controller 208 can include instructions 236 stored in the memory resource 232 and executable by the processing resource 230 to generate, via a RFID component, a RFID identifier formed of a plurality of characters. An example of a RFID identifier can include “1234456789AA” where the characters “1234456789” represent security characters identifying a user, device, and/or other element associated with the RFID component and the characters “AA” are predetermined characters that corresponds to the input. For instance, “AA” can correspond to no input being provided (e.g., at an initial time of programming of the RFID component) and can be changed, as detailed herein, to form a customized RFID identifier responsive to an input to an input mechanism of a wireless input device.

While “1234456789AA” provides an example of a RFID identifier it is understood that a total number of characters, relative location, and/or type of characters (e.g., letters, numbers, symbols, etc.) can be varied. Similarly, a total number of characters, type of characters, and/or relative location of the characters of the security characters and/or the predetermined characters within the RFID identifier can be varied. For instance, while the predetermined characters can include two predetermined characters having more or less predetermined characters is possible. For instance, in some examples an RFID identifier can include one predetermined character, among other possibilities.

The generated RFID identifier can be stored in a memory resource such as those detailed herein. For instance, in some examples the memory resource can be stored in volatile memory and/or non-volatile memory. For instance, in some examples the generated RFID can be stored in volatile memory such as a volatile memory included in a wireless input device.

In some examples, the generated RFID and/or a customized RFID identifier, as described herein can be encrypted. For instance, a predetermined private key can be sent and/or received by an RFID reader such as during initialization to promote encryption of the generated RFID and/or a customized RFID. In such examples, a RFID component can be an active RFID component and/or power assisted active RFID component to promote aspects of the encryption and/or decryption using a private key from an RFID reader.

The controller 208 can include instructions 238 stored in the memory resource 232 and executable by the processing resource 230 to transmit the RFID identifier to a host, as described herein, For instance, the controller can include instruction to cause the RFID identifier to be wirelessly transmitted to a host. As used herein, a host refers to an electronic device which can wireless communicate with a RFID component. Examples of hosts include laptops, desktops, automatic teller machines (ATMs), among other types of hosts. As used herein, “cause” or “causing” refers to directly causing an action (e.g., asserting/de-asserting a signal sent from a wireless input device and/or host) or performing an action such as sending instructions to another component to cause the action.

The controller 208 can include instructions 240 stored in the memory resource 232 and executable by the processing resource 230 to receive, via an input mechanism of the plurality of input mechanisms, an input, as detailed herein.

The controller 208 can include instructions 242 stored in the memory resource 232 and executable by the processing resource 230 to identify a predetermined character and/or a combination of a plurality of predetermined characters that corresponds to the input. For instance, an input to a space bar can correspond to the predetermined characters “SB” or other character/combination of predetermined characters that correspond to the input. A table such as lookup table can include the predetermined characters and a mapping (via a pointer or otherwise) of the predetermined characters to a given input. The table can be stored in a memory resources such as volatile and/or non-volatile memory resource included in a wireless input device and/or at other location (e.g., in a cloud computing resource and/or another device). For instance, the table can be downloaded to and/or otherwise programmed into a memory resource of the wireless input device.

The controller 208 can include instructions 246 stored in the memory resource 232 and executable by the processing resource 230 to change characters of the RFID identifier to the predetermined characters to form a customized RFID identifier. For instance, using the examples above, the “AA” in the RFID identifier can be changed to “SB” responsive to receipt of an input (e.g., depression of the spacebar key), among other possibilities. A current RFID identifier can be stored in a memory resource such as a volatile and/or non-volatile memory resource of the wireless input device.

The controller 208 can include instructions 246 stored in the memory resource 232 and executable by the processing resource 230 to transmit the customized RFID identifier to the host. For instance, the customized RFID identifier can be transmitted to the host responsive to the change in a predetermined character, at a predetermined interval, and/or in response to a read (e.g., interrogation) by a RFID reader, among other possibilities.

In any case, transmitting the customized RFID identifier to the host can permit communication of information between the wireless communication device and the host. For instance, the wireless communication device can transmit representations (e.g., predetermined characters) of inputs in real or near-real time from a user to the wireless device to the host. The host can, in some examples, display a representation of an output associated with input on a graphical user interface of the host. For instance, the host can display a space being entered in a field of text responsive to an input to a space bar of a wireless input device, among other possibilities.

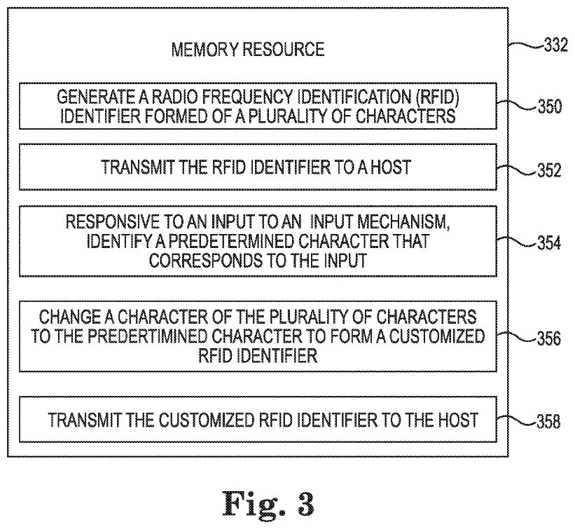

FIG. 3 is an example of a non-transitory machine readable medium 332 consistent with the disclosure. The machine readable storage medium 332 can be analogous to or similar to non-transitory machine readable medium 232. For instance, the machine readable storage medium 332 can include instructions that are executable by a processing resource such as those described herein to perform functions related to customized radio frequency identification.

In various examples, the machine readable storage medium 332 can include instructions 350, when executable by a processing resource to generate a RFID identifier formed of a plurality of characters, as described herein. In various examples, the machine readable storage medium 332 can include instructions 352 executable by a processing resource to transmit the RFID identifier to a host when executed by a processing resource, as described herein. In various examples, the machine readable storage medium 332 can include instructions 354, executable by a processing resource to responsive to an input to an input mechanism, identify a predetermined character that corresponds to the input, as described herein.

In some examples, the instructions 354 can include instructions executable by a processing resource to receive a predefined input of the plurality of predefined inputs. For instance, each input mechanism included in a wireless input device can facilitate a predetermined input (e.g., provided via a respective input mechanism such as a spacebar, key, button, switch, touch screen, and/or graphical user interface, etc.). Each predetermined input can have a corresponding predetermined character and/or a combination of predetermined characters.

In various examples, the machine readable storage medium 332 can include instructions 356, when executed by a processing resource change a character of the plurality of characters to the predetermined character to form a customized RFID identifier, as described herein. In various examples, the machine readable storage medium 332 can include instructions 356 transmit the customized RFID identifier to the host, as described herein.

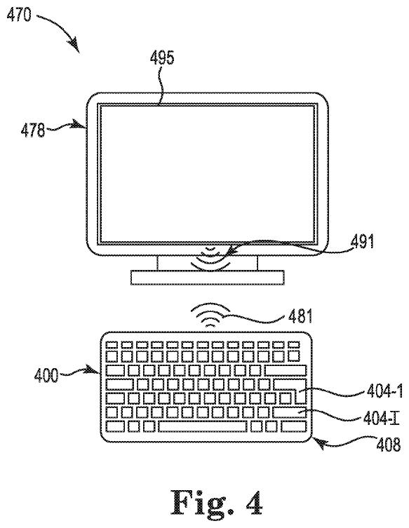

FIG. 4 is a block diagram of an example of a system 470 including a wireless input device 400 for customized radio frequency identification according to the disclosure. As illustrated in FIG. 4, the system 470 can include the wireless input device 400 and a host 478. The wireless input device 400 can be the same or analogous to wireless input device 100, 500, 600, and/or 700 of FIGS. 1, 5, 6, 7, respectively. For instance, the wireless input device can include a plurality of input mechanism 404-1, . . . , 404-I, a controller such as a first controller 408, and a RFID component such as an active RFID component 481.

The host 478 can include a RFID reader such as a passive RFID reader 491 and a second controller 495. As used herein, a passive RFID reader 491 refers to a device that is to convert radio waves from an active RFID component into its power source via inductive coupling or otherwise. In some examples, a passive RFID reader can receive signal from an active RFID component in the absence of a handshaking protocol, and therefore can receive signals in the absence of an acknowledge transmission success or fail and initiate retry, etc. messages.

The second controller 495 can include a memory resource and a processing resource such as those described herein. In various examples, the second controller 495 is to receive, via the passive RFID reader 491, the customized RFID identifier from the wireless input device 400.

As mentioned, a wireless input device such as a keyboard can be powered. For instance, by activation of a power switch and/or or when the wireless input device wakes from standby low power mode responsive to an input device being actuated, etc., such as when a key is actuated. Responsive to powering the wireless input device the first controller 408 can transmit security information via the active RFID component 481 to the passive RFID reader 491. Responsive to the same the passive RFID reader 491 can send (or initiate a read) to save the security information (e.g., a keyboard ID for authentication and use to pair with the keyboard).

The active RFID component 481 can initiate transmission of a predetermined character corresponding to a particular input device (e.g., key stroke data) along with security information as a customized RFID identifier. That is, while that predetermined characters change responsive to an input, the security information included in a customized RFID identifier can remain unchanged to permit periodic or other types of authentication of wireless input device. For instance, the second controller 495 can check a data security key (ID) included in the security information to confirm the data security key (ID) matches with the wireless input device (e.g., based on information stored at the host or otherwise). If the information does not match, the host can cease to process input information (e.g., key stroke data) or other information received from the wireless input device. If the information matches the host can continue to receive customized RFID identifiers from the wireless input device and process the same. For instance, the second controller 495 can process information such as key stroke data (based on the predetermined characters) and pass the information (e.g., key scan-codes and/or other information) to an OS driver, among other possibilities.

In various examples, the second controller 495 is to perform, at the host, an operation based on the received customized RFID identifier. Examples of operations include: changing a representation on a graphical user interface of the host, altering a setting of the host, selection of an icon represented on a graphical user interface of the host, movement of a cursor represented on a graphical user interface of the host, addition/deletion of a text character, symbol, or other element in a field represented on the graphical user interface of the host, among other possible operations.

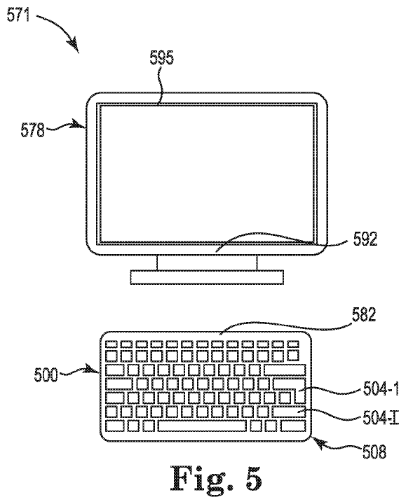

While FIG. 4 describes a passive RFID reader 491 and an active RFID component the disclosure is not so limited. For instance, FIG. 5 is a block diagram of another example of a system including a wireless input device for customized radio frequency identification according to the disclosure. As illustrated in FIG. 5, the system 571 can include the wireless input device 500 and a host 578. The wireless input device 500 can be the same or analogous to wireless input device 100, 400, 600, and/or 700 of FIGS. 1, 4, 6, 7, respectively. For instance, the wireless input device 500 can include a plurality of input mechanism 504-1, . . . , 504-I, a controller such as the first controller 508, and a RFID component such as a passive RFID component 582. The passive RFID component 582 can be read by an active RFID reader, such as active RFID reader 592, to provide information including a protocol response such as acknowledge or retry response so that the information can be stored (e.g., in a buffer or other memory resource). As used herein, an active RFID reader refers to a device that is to interact with a passive RFID reader and/or an active RFID reader. For instance, an active RFID reader can: a). send radio waves with a particular frequency continuously or near-continuously; b). read a passive RFID information in form of load modulation; and/or c) receive back-scattered signal from an active RFID component.

The host 578 can include a RFID reader such as an active RFID reader 592 and a second controller 595. The second controller 595 can include a memory resource and a processing resource such as those described herein. The second controller 595 is to receive, via the active RFID reader 592, the customized RFID identifier from the wireless input device 500. For instance, in some examples,

The second controller 595 can cause the active RFID reader 592 to transmit a signal such as an interrogator signal to initiate receipt of response information (e.g., predetermined identifiers corresponding to key strokes) from the wireless input device. In such examples, the passive RFID component 582 can receive power from radio energy transmitted by the active RFID reader 592. Responsive to receipt of the radio energy via the passive RFID component 582, the first controller 508 can cause scanning or other analysis of the input mechanisms such as to detect scan-line signals indicative of a key actuation and/or release. That is, the first controller 508 can provide information (e.g., encoded key scan-line signals and/or customized RFIDS including predetermined characters corresponding to the respective scan-line signals) to passive RFD component 582 which can then transmit the information (e.g., customized RFIDs) to the active RFID reader 592 responsive to the interrogator signal. However, the disclosure is not so limited. Rather, in some examples, the first controller 508 can respond with delay request to extend cycle for the active RFID reader to continue transmitting null signal in purpose of continuing to generate radio energy to power the first controller 508 and/or other operation of the wireless input device 500.

In some examples, upon receiving the information (e.g., encoded key scan-line signals and/or predetermined characters corresponding to the respective scan-line signals), the second controller 595 checks securing information such as security key (ID) for authentication and if it matches the paired wireless input device (e.g., a keyboard). If yes, then the input mechanism key stroke data to pass the information (e.g., key scan-codes) to OS driver to permit authorization of wireless input device 500. When authorized, the second controller 595 is to perform, at the host, an operation such as those described herein based on the received customized RFID identifier. If no, the second controller 595 can cause the active RFID reader 592 to request the wireless input device 500 retry sending information (e.g., key scan-line signals or predetermined characters corresponding to the respective scan-line signals) by continuing to transmit radio energy until a successful read or a timeout after a threshold amount of time and/or retry attempts.

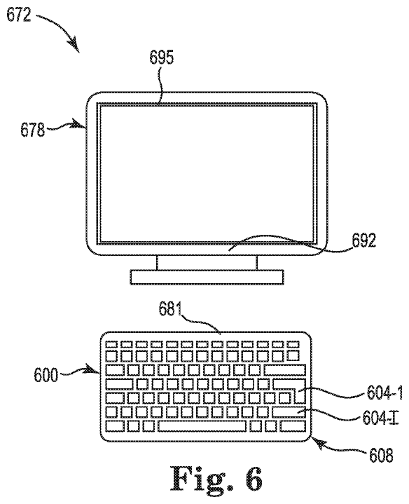

FIG. 6 is a block diagram of yet another example of a system 672 including a wireless input device for customized radio frequency identification according to the disclosure. As illustrated in FIG. 6, the system 672 can include the wireless input device 600 and a host 678. The wireless input device 600 can be the same or analogous to wireless input device 100, 400, 500, and/or 700 of FIGS. 1, 4, 5, 7, respectively. For instance, the wireless input device 600 can include a plurality of input mechanism 604-1, . . . , 604-I, a first controller 608, and a RFID component such as an active RFID component 681.

The host 678 can include a RFID reader such as an active RFID reader 692 and a second controller 695, The second controller can include a memory resource and a processing resource such as those described herein. In various examples, the second controller 695 is to receive, via the active RFID reader 692, the customized RFID identifier from the wireless input device 600.

In various examples a wireless input device such as a keyboard can be powered. For instance, by activation of a power switch and/or or when the wireless input device wakes from standby low power mode responsive to an input device being actuated, etc., such as when a key is actuated. Responsive to powering of the wireless input device the first controller 608 can transmit security information via the active RFID component 681 to the active RFID reader 692 to permit authentication of the wireless input device 600. When authenticated, the first controller 608 can cause active RFID component 681 to initiate a read from active RFID reader 692. The active RFID reader can receive the request to initiate the read and send an interrogator signal to the wireless input device 600. The active RFID component 681 can use its own power source and/or power from radio energy transmitted by active RFID reader to transmit information (e.g., key scan-line signals or predetermined characters corresponding to the respective scan-line signals) saved in a memory resource such as a battery powered memory buffer to the active RFID reader 692.

In some examples, the second controller 695 can use hand-shaking protocol to authenticate wireless input device, as described herein. In various examples, the second controller 695 is to perform, at the host, an operation such as those described herein based on the received customized RFID identifier.

FIG. 7 is a block diagram of still another example of a system 773 including a wireless input device for customized radio frequency identification according to the disclosure. As illustrated in FIG. 7, the system 773 can include a wireless input device 700 and a host 778.

The wireless input device 700 can be the same or analogous to wireless input device 100, 400, 500, and/or 600 of FIGS. 1, 4, 5, 6, respectively. For instance, the wireless input device 700 can include a plurality of input mechanism 704-1, . . . , 704-I, a first controller 708, and a RFID component such as a passive RFID component 782, and plurality of passive RFID transponders (identified as 797). For example, as illustrated in FIG. 7, wireless input device 700 can include keyboard including a plurality of keys included in the input mechanisms 704-1, . . . , 704-I. In such examples, a key of the plurality of keys can include a respective transponder to send a customized RFID identifier corresponding to the respective key responsive to actuation of the key to the host 778.

The host 778 can be the same or analogous to host 400, 500, and/or 600 of FIGS. 4, 5, and 6, respectively. The host 778 can include a RFID reader such as an active RFID reader 792 and a second controller 795. The second controller 795 can include a memory resource and a processing resource such as those described herein. In various examples, the second controller 795 is to receive, via the active RFID reader 792, the customized RFID identifier from the wireless input device 700.

The second controller 795 can cause active RFID reader 792 to transmit an interrogator signal to a passive RFID component 782 and to an array of plurality of passive RFID transponders (e.g., micro transponders) 797. The first controller 708, the passive RFID component 782, and/or the plurality of passive RFID transponders can receive power from radio energy transmitted by the active RFID reader 792 to permit various operations, as described herein, such as detection of an input, storing of predetermined characters, changing of characters and/or transmission of information, among other operations. In some examples, the first controller 708 can respond (e.g., to an interrogator signal) with a delay request to extend cycle for the active RFID reader 792 to continue transmitting null signal in purpose of continuing to generate radio energy to power the first controller 708, the passive RFID component, and/or the array of plurality of passive RFID transponders 797 to permit various operations of the wireless input device 700.

In some examples, the wireless input device can be a wireless mouse 798. In such examples, an input can include movement of the wireless mouse (relative to a surface on which the wireless mouse is located), actuation of a button and/or trackball included in the wireless mouse, among other possibilities.

In some examples, the second controller 795 can use hand-shaking protocol to authenticate wireless input device, as described herein. In various examples, the second controller 795 is to perform, at the host, an operation such as those described herein based on the received customized RFID identifier.

In various examples, a host and/or a wireless input device can be free of additional wireless hardware (e.g., in addition to RFID hardware). For instance, in some examples each of a host and a wireless input device can be free of BLUETOOTH® based wireless hardware/antennae),

In the foregoing detailed description of the disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. As used herein, the designator “M”, particularly with respect to reference numerals in the drawings, indicates that a plurality of the particular feature so designated can be included with examples of the disclosure. The designators can represent the same or different numbers of the particular features.

What is claimed:

1. A non-transitory machine readable medium including instructions executable to a processing resource to:
generate a radio frequency identification (RFID) identifier formed of a plurality of characters;
transmit the RFID identifier to a host;
responsive to an input to an input mechanism, identify a predetermined character that corresponds to the input;
change a character of the plurality of characters to the predetermined character to form a customized RFID identifier; and
transmit the customized RFID identifier to the host.

2. The medium of claim 1, further comprising instruction to identify the predetermined character from a memory resource storing a plurality of predetermined characters identifying a plurality of predefined inputs.

3. The medium of claim 2, further comprising instructions to receive a predefined input of the plurality of predefined inputs to a wireless input device.

4. The medium of claim 3, wherein input mechanism includes a key, a switch, a button, or a touch screen, and wherein the input further comprises:
actuation of the key or the button;
actuation of the switch, or
contact or an absence of contact with the touch screen.

5. The medium of claim 4, further comprising instructions to identify a predetermined character that corresponds to:
depression of a key of a plurality of keys of the wireless input device; or
release of a key of the plurality of keys of the wireless input device.

6. The medium of claim 4, further comprising instructions to identify a predetermined character that corresponds to:
activation of a switch of the wireless input device; or
deactivation of a switch of the wireless input device.

7. The medium of claim 6, further comprising instructions to identify a predetermined character that corresponds to:
depression of an individual key of a plurality of keys of the wireless input device; or
release of an individual key of the plurality of keys of the wireless input device.

8. The medium of claim 1, wherein the customized RFID identifier includes the plurality of predefined characters and a plurality of security characters.

9. A wireless input device including:
a plurality of input mechanisms;
a radio frequency identification (RFID) component;
a controller to:
generate, via the RFID component, a RFID identifier formed of a plurality of characters;
transmit the RFID identifier to a host;
receive, via an input mechanism of the plurality of input mechanisms, an input;
identify a combination of a plurality of predetermined characters that corresponds to the input;
change characters of the RFID identifier to the predetermined characters to form a customized RFID identifier; and
transmit the customized RFID identifier to the host.

10. The wireless input device of claim 9, wherein the wireless input device further comprises a wireless keyboard or a wireless mouse.

12. A system comprising:
a wireless input device including:
a plurality of input mechanisms;
a radio frequency identification (RFID) component;
a first controller to:
generate a RFID identifier formed of a plurality of characters;
receive an input to an input mechanism of the plurality of input mechanisms;
identify a predetermined character that corresponds to the input; and
change a character of the plurality of characters of the RFID identifier to the predetermined character to form a customized RFID identifier; and
a host including:
a RFID reader; and
a second controller to:
receive, via the RFID reader, the customized RFID identifier from the wireless input device; and
perform an operation based on the received customized RFID identifier.

13. The system of claim 12, wherein the instructions to perform the operation further comprises instructions to display a representation of an output associated with input on a graphical user interface of the host.

14. The system of 12, wherein the RFID component further comprises:
a passive RFID component, and wherein the host includes an active RFID reader; or
an active RFID component, and wherein the host includes a passive RFID reader or an active RFID reader.

15. The system of claim 12, wherein the wireless input device further comprises a keyboard including a plurality of keys, and wherein each key of the plurality of keys includes a respective transponder to send a customized RFID identifier corresponding to the respective key responsive to actuation of the key, and wherein the host further comprises an active RFID reader.
